(19) United States
(12) Patent Application Publication
(10) Pub. No.: US 2018/0173452 A1
(43) Pub. Date: Jun. 21, 2018

(54) APPARATUS FOR HYPER CONVERGED INFRASTRUCTURE

(71) Applicant: EMC IP Holding Company LLC, Hopkinton, MA (US)

(72) Inventors: Sandburg Hao Hu, Shanghai (CN); Adam Xiang Yu, Shanghai (CN); Fred Bo Gao, Shanghai (CN); Jing Chen, Epping (AU); Sean Xu Chen, Shanghai (CN)

(21) Appl. No.: 15/846,666

(22) Filed: Dec. 19, 2017

(30) Foreign Application Priority Data
Dec. 21, 2016 (CN) 201611194063.0

(51) Int. Cl. G06F 3/06

(52) U.S. Cl. CPC G06F 3/0644; G06F 3/0683; G06F 3/0604

(57) ABSTRACT

Embodiments of the present disclosure provide an apparatus for a hyper converged infrastructure. The apparatus comprises at least one compute node each including a first number of storage disks. The apparatus further comprises a storage node including a second number of storage disks available for the at least one compute node, the second number being greater than the first number. The embodiments of the present disclosure also provide a method of assembling the apparatus for the hyper converged architecture.

### RELATED APPLICATIONS

This application claim priority from Chinese Patent Application Number CN201611194063.0, filed on Dec. 21, 2016 at the State Intellectual Property Office, China, titled “APPARATUS FOR HYPER CONVERGED INFRASTRUCTURE” the contents of which is herein incorporated by reference in its entirety.

### FIELD

The present disclosure generally relates to the technical field related to computers, and more particularly to an apparatus for a hyper converged infrastructure and an assembling method thereof.

### BACKGROUND

Hyper Converged Infrastructure (HCI) combines computing applications and storage applications into a single infrastructure, which gains rapidly growing customer attractions. While there are numerous HCI hardware offerings in the market, 2U4N (4 computing nodes in 2U chassis) is most widely used. Also, alike platforms are adopted by major HCI vendors.

### SUMMARY

Embodiments of the present disclosure provide an apparatus for a hyper converged infrastructure and a method of assembling such an apparatus.

According to a first aspect of the present disclosure, there is provided an apparatus for a hyper converged infrastructure. The apparatus includes at least one computing node and a storage node. The at least one computing node each includes a first number of storage disks. The storage node includes a second number of storage disks. The second number of storage disks are available for the at least one computing node. The second number is greater than the first number.

In some embodiments, the storage node may further include a storage disk controller associated with a respective one of the at least one computing node. The storage disk controller is provided for the respective computing node to control a storage disk of the second number of storage disks allocated to the respective computing node.

In some embodiments, the at least one computing node may include a plurality of computing nodes. The second number of storage disks may be evenly allocated to the plurality of computing nodes.

In some embodiments, the at least one computing node may each further include at least one of a central processing unit, a memory and a first interface. The storage node may further include a second interface.

In some embodiments, the apparatus may further include a mid-plane. The mid-plane includes an interface adapted to interface with the first interface and the second interface to establish a connection between the at least one computing node and the storage node.

In some embodiments, the mid-plane may connect the at least one computing node and the storage node to at least one of a power supply module, an I/O module and a management module in the apparatus.

In some embodiments, the first interface and the second interface may conform to a same specification.

In some embodiments, the at least one computing node may include three computing nodes. The first number of storage disks may include six storage disks. The second number of storage disks may include fifteen storage disks.

In some embodiments, the at least one computing node may include a plurality of computing nodes. The apparatus may further include a multi-layer chassis. The multi-layer chassis at least includes a first layer and a second layer. A part of the plurality of computing nodes is mounted on the first layer. A further part of the plurality of computing nodes and the storage node are mounted on the second layer.

In some embodiments, the multi-layer chassis may be a 2U chassis.

In some embodiments, the plurality of computing nodes and the storage node are of a same shape.

In some embodiments, the storage node may further include a fan. The storage disk, the storage disk controller and the fan may be disposed on a movable tray and connected into the storage node via an elastic cable.

According to a second aspect of the present disclosure, there is provided a method of assembling the above apparatus.

### BRIEF DESCRIPTION OF THE DRAWINGS

Through the following detailed description with reference to the accompanying drawings, the above and other objectives, features, and advantages of example embodiments of the present disclosure will become more apparent. Several example embodiments of the present disclosure will be illustrated by way of example but not limitation in the drawings in which:

FIG. 1 illustrates a schematic diagram of a typical hyper converged infrastructure apparatus;

FIG. 2 illustrates a schematic diagram of an apparatus for a hyper converged infrastructure according to an embodiment of the present disclosure;

FIG. 3 illustrates a modularized block diagram of an apparatus for a hyper converged infrastructure according to an embodiment of the present disclosure;

FIG. 4 illustrates chassis front views of a typical hyper converged infrastructure apparatus and an apparatus for a hyper converged infrastructure according to an embodiment of the present disclosure;

FIG. 5 illustrates a top view of an apparatus for a hyper converged infrastructure according to an embodiment of the present disclosure;

FIG. 6 illustrates a top view of a storage node in a service mode in an apparatus for a hyper converged infrastructure according to an embodiment of the present disclosure; and

FIG. 7 illustrates a flow chart of a method of assembling an apparatus for a hyper converged infrastructure according to an embodiment of the present disclosure.

Throughout all figures, identical or like reference numbers are used to represent identical or like elements.

### DETAILED DESCRIPTION OF EMBODIMENTS

The principles and spirit of the present disclosure are described below with reference to several exemplary embodiments shown in the figures. It should be appreciated that these embodiments are only intended to enable those skilled in the art to better understand and implement the present disclosure, not to limit the scope of the present disclosure in any manner.

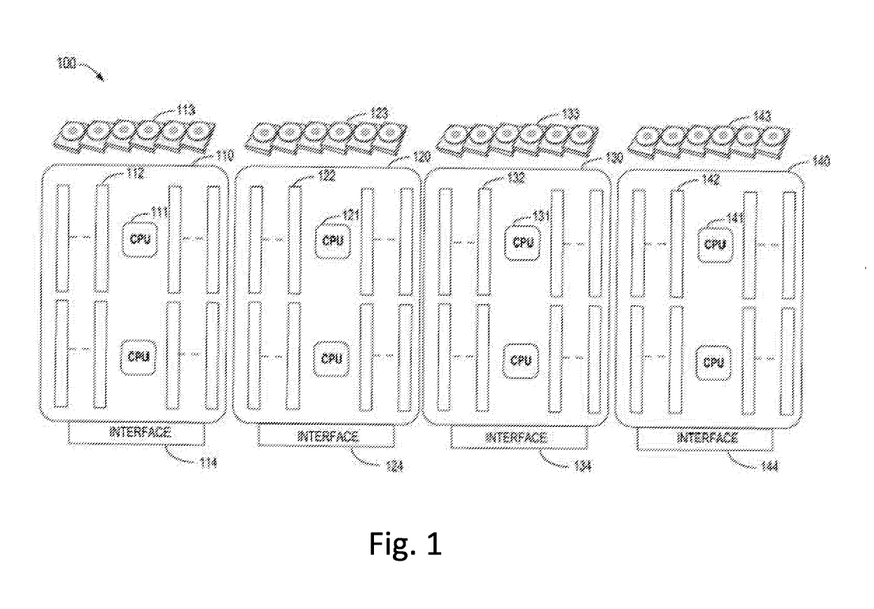

FIG. 1 illustrates a schematic diagram of a typical hyper converged infrastructure (HCI) apparatus 100. As shown in FIG. 1, the apparatus 100 includes computing nodes 110, 120, 130 and 140 for providing the apparatus 100 with computing capability and storage capability. Usually, the computing nodes 110, 120, 130 and 140 may each include central processing units (CPUs) 111, 121, 131 and 141, memories 112, 122, 132 and 142, storage disks 113, 123, 133 and 143, and interfaces 114, 124, 134 and 144. Although the computing nodes 110, 120, 130 and 140 are shown in FIG. 1 as having the same components and structures, it should be appreciated that in other possible scenarios, the computing nodes 110, 120, 130 and 140 may have different components and structures. In addition, it should be appreciated that although FIG. 1 shows the apparatus 100 as including four computing nodes 110, 120, 130 and 140, the apparatus 100 may include a different number of computing nodes in other possible scenarios.

In the computing nodes 110, 120, 130 and 140, the CPUs 111, 121, 131 and 141 are responsible for processing and controlling functions in respective computing nodes and other functions adapted to be performed by CPUs, and are mainly used to provide the computing capability to the respective computing nodes. The memories 112, 122, 132 and 142 generally refer to storage devices which may be quickly accessed by the CPUs, for example, Radom Access Memory (RAM), Double Data Rate Synchronous Dynamic Random Memory (DDR) and the like, and they generally have a small storage capacity and are mainly used to assist respective CPUs in providing the computing capability to respective computing nodes. In contrast, the storage disks 113, 123, 133 and 143 generally refer to storage devices providing the storage capability to the respective computing nodes, for example, Hard Disk Drive (HDD), and they have a larger storage capacity than the memories in the respective computing nodes. The interfaces 114, 124, 134 and 144 are responsible for interfacing the respective computing nodes with other modules and units in the apparatus 100, for example, a power supply module, a management module, and an input/output (I/O) module, etc.

For the purpose of illustration, FIG. 1 depicts that the computing nodes 110, 120, 130 and 140 include a specific number of CPUs, a specific number of memories, a specific number of storage disks, and a specific number of interfaces. However, it should be appreciated that under conditions of different application environments and design demands, the computing nodes 110, 120, 130 and 140 may include a different number of CPUs, memories, storage disks, and interfaces. In addition, it should be appreciated that the computing nodes 110, 120, 130 and 140 may further include various other functional components or units, but FIG. 1 only depicts the functional components or units in the computing nodes 110, 120, 130 and 140 related to embodiments of the present disclosure for brevity.

In a typical structural configuration of the apparatus 100, the computing nodes 110, 120, 130 and 140 may be assembled according to a 2U4N system architecture, wherein 2U represents a 2U chassis (1U=1.75 inches) and 4N represents four nodes. In such a structural configuration, four computing nodes 110, 120, 130 and 140 are installed in the 2U chassis. On top of the computing nodes 110, 120, 130 and 140, HCI application software may federate the resources across each computing node, and provide a user of the apparatus 100 with the computing service and storage service. In addition, a three-copy replication algorithm may be used to provide the apparatus 100 with data redundancy and protection.

In the example depicted in FIG. 1, the respective computing nodes 110, 120, 130 and 140 include respective six storage disks 113, 123, 133 and 143 to provide the storage capability to the apparatus 100. It should be appreciated that although the computing nodes 110, 120, 130 and 140 are depicted as including six storage disks in FIG. 1, they may include more or less storage disks depending on different application scenarios and design demands. However, since the computing nodes 110, 120, 130 and 140 need to provide the apparatus 100 with the computing capability, they can only provide limited storage capability to the apparatus 100, namely, can include only a relatively small number of storage disks.

Therefore, although the apparatus 100 employing the 2U4N architecture may provide great compute capability, it has various deficiencies as an HCI building block. First, the storage capacity of the apparatus 100 is insufficient. Six storage disks (e.g., 2.5 inch hard disks) for each computing node may not meet many storage capacity demanding applications. Secondly, a ratio of the storage disks to the CPUs of the apparatus 100 is locked. In the case that the number of storage disks is six and the number of CPUs is two, the ratio is 3:1. For customers who hope to merely expand the storage capacity without expanding the compute capability, they have to add a computing node with CPUs to increase the storage capacity. Thirdly, the apparatus 100, as an entry level HCI product, has a high cost overhead. In fact, the minimum system configuration for a typical HCI appliance with three-copy replications requires only a three-node platform. The apparatus 100 with the 2U4N structure is equipped with four computing nodes which add a cost burden for an entry product.

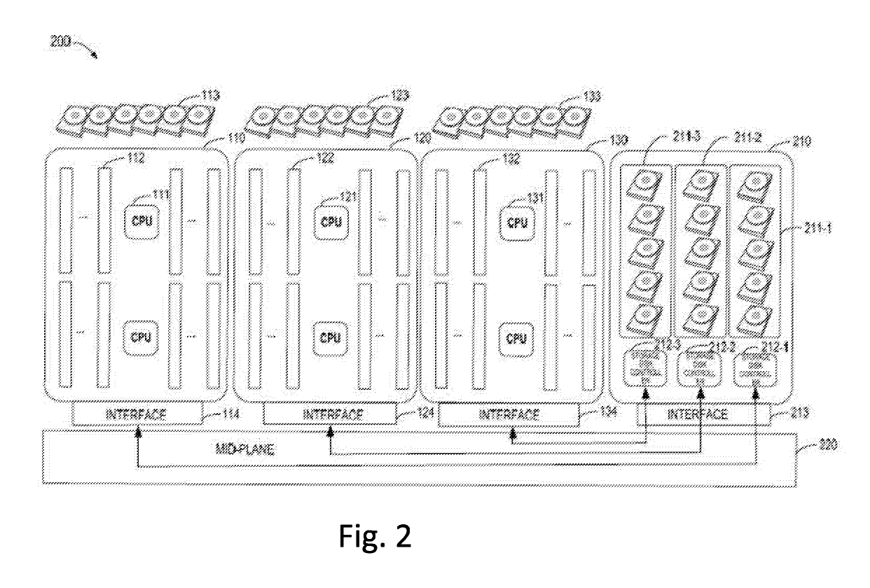

To at least solve in part the above and other potential problems, embodiments of the present disclosure provide an elastic storage platform optimized for HCI, intended to be used as a more storage capacity optimized and cost effective building block for HCI products. According to embodiments of the present disclosure, there are provided an apparatus for a hyper converged infrastructure and a method of assembling the apparatus for the hyper converged infrastructure, to meet the needs of HCI applications. In embodiments of the present disclosure, a storage node is designed which can optionally replace a computing node in the same chassis and hold a larger number of storage disks. These additional storage disks may be divided into storage disk groups, which groups can respectively attach to each node for use by the computing node. In the following, reference is made to FIGS. 2-7 to specifically describe the apparatus and method according to embodiments of the present disclosure.

FIG. 2 illustrates a schematic view of an apparatus 200 for a hyper converged infrastructure according to an embodiment of the present disclosure. As shown in FIG. 2, the apparatus 200 includes computing nodes 110, 120 and 130, and a storage node 210. The computing node 110, 120 and 130 each include a first number of storage disks 113, 123 and 133. The storage node 210 includes a second number of storage disks 211 (storage disk groups 211-1, 211-2 and 211-3 are collectively be referred to as the storage disk 211). The second number is greater than the first number. This is because the storage node 210 may include a larger number of storage disks, unlike the compute nodes 110, 120 and 130 which need to include components such as CPUs 111, 121, 131 and/or memories 112, 122, 132, or the like.

Although FIG. 2 shows the computing nodes 110, 120 and 130 as each including six storage disks 113, 123 and 133, and shows the storage node 210 as including fifteen storage disks 211, it should be appreciated that this is only an example. In other embodiments, the computing nodes 110, 120 and 130 and the storage node 210 may include more or less storage disks. In addition, although FIG. 2 shows the apparatus 200 as including three computing nodes 110, 120 and 130, it should be appreciated that this is only an example. In other embodiments, the apparatus 200 may include more or less computing nodes. Similarly, all specific numbers described in the description are only intended to enable those skilled in the art to better understand ideas and principles of embodiments of the present disclosure, not to limit the scope of the present disclosure in any manner.

The second number of storage disks 211 in the storage node 210 are available for the computing nodes 110, 120 and 130, to facilitate expansion of their storage capability. To this end, the apparatus 200 may further include storage disk controllers 212-1, 212-2, 212-3 (collectively referred to as storage disk controller 212) associated with the respective computing nodes 110, 120 and 130. The storage disk controllers 212-1, 212-2, and 212-3 may be used by the respective computing nodes 110, 120, 130 to control a storage disk allocated to the respective computing nodes 110, 120, 130. In the example of FIG. 2, fifteen storage disks 211 in the storage node 210 are logically divided into three storage disk groups 211-1, 211-2, 211-3 to be allocated to the respective computing nodes 110, 120, 130. It should be appreciated that although the storage disks 211 are evenly allocated to the computing nodes 110, 120, 130 in FIG. 2, this is only an example. In other embodiments, the storage disks 211 may be unevenly allocated to the respective computing nodes 110, 120, 130.

In this way, the apparatus 200 may provide the user with an enhancement from four computing nodes each having six storage disks (FIG. 1) to three computing node each evenly having eleven (6+5) storage disks (FIG. 2). In an embodiment with two CPUs, this may increase the ratio of the storage disks to the CPUs from 3 to 5.5, and achieves an increase over 80%. This is very useful for expanding the application scenarios of the apparatus 200 for different platforms, especially to entry level capacity demanding applications. It is noted that these numbers are only examples and not intend to limit the scope of the present disclosure in any manner.

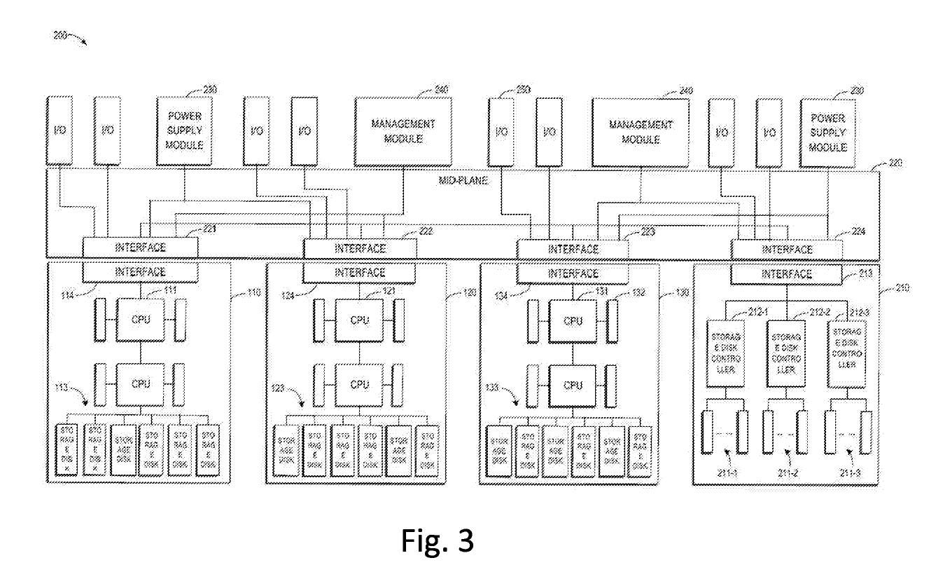

Further referring to FIG. 2, the apparatus 200 may further include a mid-plane 220. The mid-plane 220 includes an interface adapted to interface with the interfaces 114, 124, 134 of the computing nodes 110, 120, 130 and the interface 213 of the storage node 210, to establish a connection between the computing nodes 110, 120, 130 and the storage node 210. In some embodiments, the interfaces 114, 124, 134 and the interface 213 may conform to a same specification so that the interface of the mid-plane 220 for interfacing with the storage node 210 may also interface with the computing node (e.g., computing node 140 in FIG. 1). In some embodiments, each storage disk group 211-1, 211-2, 211-3 may be connected to respective hosting computing nodes 110, 120, 130 via a PCIe connection on the mid-plane 220. In the following, reference is made to FIG. 3 to describe several exemplary implementations of the apparatus 200, particularly the example details related to the mid-plane 220.

FIG. 3 illustrates a modularized block diagram of the apparatus 200 for the hyper converged infrastructure according to an embodiment of the present disclosure. It should be appreciated that FIG. 3 only shows various modules and units related to embodiments of the present disclosure for sake of brevity. In specific embodiments, the computing nodes 110, 120, 130, the storage node 210 and the mid-plane 220 may further include various other functional modules or units.

As shown in FIG. 3, the computing nodes 110, 120, 130 interface with the interfaces 221, 222, 223 of the mid-plane 220 via respective interfaces 114, 124, 134 respectively, and the storage node 210 interfaces with the interface 224 of the mid-plane 220 via the interface 213. In the mid-plane 220, a connection between the computing nodes 110, 120, 130 and the storage node 210 is established by implementing a connection among the interfaces 221, 222, 223, 224.

In addition, the mid-plane 220 further connect the computing nodes 110, 120, 130 and the storage node 210 to other modules or units in the apparatus 200 respectively via the interfaces 221, 222, 223, 224. For example, other modules or units may include and not limited to a power supply module 230, a management module 240 and an I/O module 250, thereby performing power supply control, management control and an input/output function for the computing nodes 110, 120, 130 and the storage node 210. It should be appreciated that although FIG. 3 shows a specific number of power supply modules 230, management modules 240 and I/O modules 250, this is only an example. More or less than these modules may be arranged under other application scenarios and design demands.

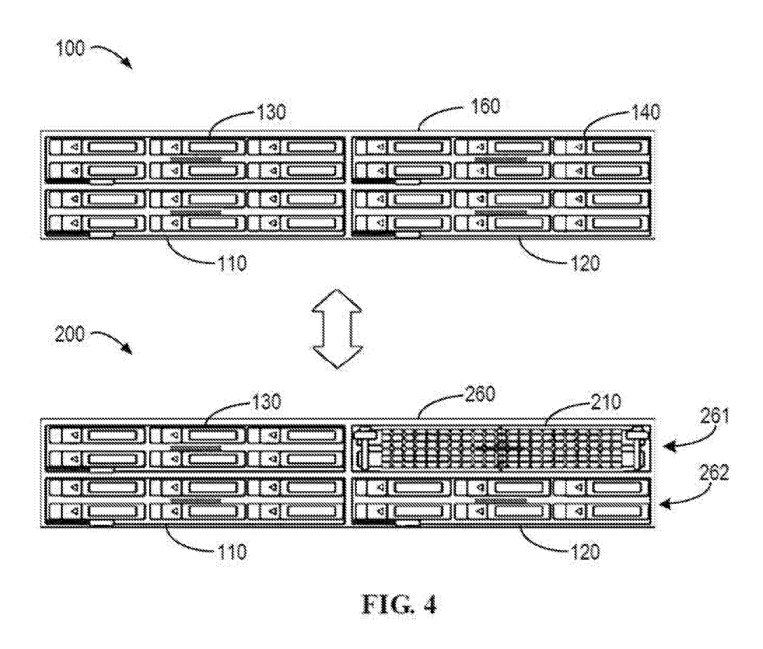

In the above, features of the apparatus 200 are described from a perspective of units or components included in the apparatus 200 with reference to FIG. 2 and FIG. 3. In the following, possible favorable characteristics of the apparatus 200 in terms of mechanical structures and arrangements will be described with reference to FIG. 4-FIG. 6. FIG. 4 illustrates chassis front views of a typical hyper converged infrastructure apparatus 100 and the apparatus 200 for the hyper converged infrastructure according to an embodiment of the present disclosure. As shown in an upper portion of FIG. 4, the computing nodes 110-140 of the typical hyper converged infrastructure apparatus 100 may be mounted in an upper layer and a lower layer in a two-layer chassis 160, with two computing nodes in the computing nodes 110-140 being mounted in each layer.

As shown in a lower portion of FIG. 4, similar to the chassis structure of the apparatus 100, the apparatus 200 for the hyper converged infrastructure according to an embodiment of the present disclosure may include a multi-layer chassis 260. The multi-layer chassis 260 at least includes a first layer 261 and a second layer 262. The computing nodes 110 and 120 of the apparatus 200 may be mounted on the first layer 261. The computing node 130 and the storage node 210 of the apparatus 200 are mounted on the second layer 262. In some embodiments, the multi-layer chassis 260 may be a 2U chassis.

In an embodiment, the two-layer chassis 160 of the apparatus 100 may be used as the multi-layer chassis 260 of the apparatus 200. In particular, a slot at a right upper corner of the two-layer chassis 160 is configured, on demand, for the computing node 140 or the storage node 210. When it is configured for the storage node 210, the storage node 210 may provide additional storage disk expansion capability to the computing nodes 110, 120, 130. To this end, the computing nodes 110, 120, 130, 140 and the storage node 210 may have a same shape, so that they may be used to replace a computing node in a certain slot in the apparatus 100 in an HCI configuration demanding high storage.

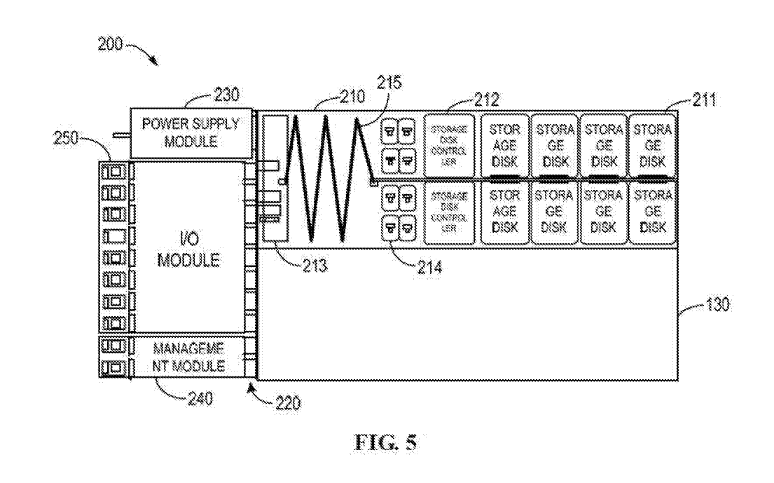

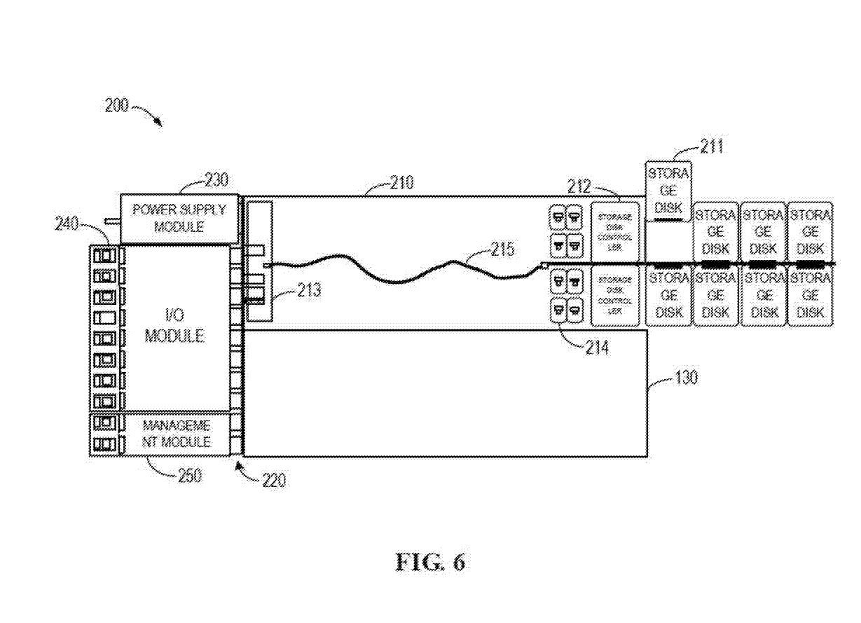

In the following, reference is made to FIG. 5 and FIG. 6 to describe various components in the storage node 210 and an example layout thereof. FIG. 5 illustrates a top view of the apparatus 200 for the hyper converged infrastructure according to an embodiment of the present disclosure. In FIG. 5, a transparent top view of the apparatus 200 is provided to illustrate an internal layout of each component in the apparatus 200.

As shown in FIG. 5, the computing node 130 and the storage node 210 in the first layer 261 of the multi-layer chassis 260 are respectively shown in a lower portion and an upper portion of a right portion of FIG. 5, and they are connected, via the mid-plane 220, to the power supply module 230, the management module 240 and the I/O module 240 shown on the left side of FIG. 5. For purpose of brevity, FIG. 5 does not show specific details of the computing node 130 and mid-plane 220.

As depicted in FIG. 5, in addition to the storage disks 211 and the storage disk controllers 212 discussed above, the storage node 210 may further include one or more fans 214 to provide cooling in the storage node 210. The storage disks 211, the storage disk controllers 212 and the fans 214 may be disposed on a movable tray (not shown) and connected into the storage node 210 via an elastic cable 215.

In an embodiment, the storage disks 211 may be disposed in the storage node 210 in two layers, with two rows being in each layer. The storage disk controllers 212 are placed transversely back to back. As an example, if the number of the storage disks 211 is fifteen, each row of the upper two rows of storage disks includes four storage disks, while for the lower two rows of storage disks, one row includes four storage disks and the other row includes three storage disks. In addition, the storage nodes 210 may be designed in a high availability fashion and each component can be operated (e.g., repaired, replaced, or configured) by being pulled out of the chassis 260, and in the meanwhile, the operation of the storage node 210 is maintained. This is described below with reference to FIG. 6.

FIG. 6 illustrates a top view of a storage node 210 in a service mode of the apparatus 200 for the hyper converged infrastructure according to an embodiment of the present disclosure. As shown in FIG. 6, all the active components (the storage disks 211, the storage disk controllers 212 and the fans 214) which can be field-replaceable are mounted on a movable tray (not shown) which can be pulled out of the chassis 260. The elastic cable 215 attached to the tray provides signal connectivity and power delivery when the tray travels, and thus remain the storage node 210 to be fully functional. In an embodiment, the storage disks 211 and the storage disk controllers 212 can be slide out or in from either left or right side of the chassis 260 and the fans 214 can be operated from the top of the chassis 260.

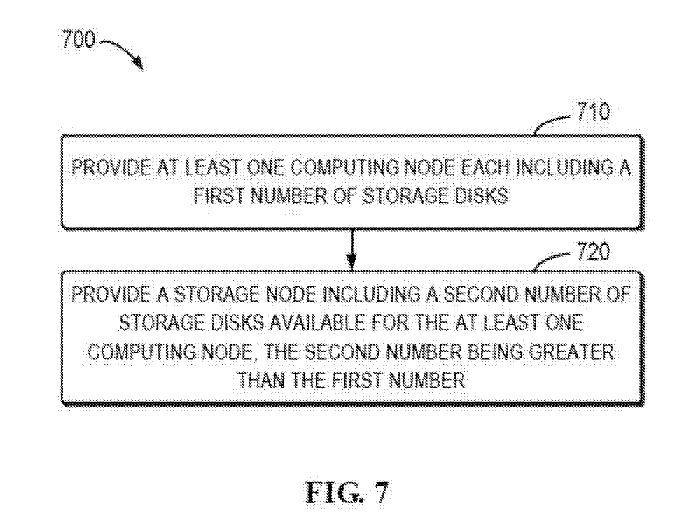

FIG. 7 illustrates a flow chart of a method 700 of assembling the apparatus 200 for the hyper converged infrastructure according to an embodiment of the present disclosure. As shown in FIG. 7, at 710, at least one computing node is provided, which each includes a first number of storage disks. At 720, a storage node is provided which includes a second number of storage disks. The second number of storage disks are available for the at least one computing node, and the second number is greater than the first number.

In some embodiments, providing the at least one computing node may include providing a plurality of computing nodes. Furthermore, the method 700 may further include evenly allocating the second number of storage disks to the plurality of computing nodes. In some embodiment, providing the at least one computing node may include providing three computing nodes, the first number of storage disks may include six storage disks, and the second number of storage disks may include fifteen storage disks.

In some embodiments, the method 700 may further include arranging, in the storage node, a storage disk controller associated with a respective one of the at least one computing node, the storage disk controller is provided for the respective computing node to control a storage disk allocated to the respective computing node of the second number of storage disks. In some embodiments, the at least one computing node may each further include at least one of a central processing unit, a memory and a first interface. The storage node may further include a second interface.

In some embodiments, the method 700 may further include providing a mid-plane which includes an interface adapted to interface with the first interface and the second interface to establish a connection between the at least one computing node and the storage node. In some embodiments, the method 700 may further include connecting, via the mid-plane, the at least one computing node and the storage node to at least one of a power supply module, an I/O module and a management module in the apparatus. In some embodiments, the method 700 may further include setting the first interface and the second interface to conform to a same specification.

In some embodiments, providing the at least one computing node may include providing a plurality of computing nodes. Furthermore, the method 700 may further include providing a multi-layer chassis which at least includes a first layer and a second layer; mounting a part of the plurality of computing nodes on the first layer; and mounting a further part of the plurality of computing nodes and the storage node on the second layer. In some embodiments, providing the multi-layer chassis may include providing a 2U chassis. In some embodiments, the method 700 may further include setting the plurality of computing nodes and the storage node to be of a same shape. In some embodiments, the method 700 may further include providing a fan in the storage node; and disposing the storage disk, the storage disk controller and the fan on a movable tray and connecting them into the storage node via an elastic cable.

As used in the text, the term “include” and like wording should be understood to be open-ended, i.e., to mean “including but not limited to”. The term “based on” should be understood as “at least partially based on”. The term “an embodiment” or “the embodiment” should be understood as “at least one embodiment”. As used in the text, the term “determine” covers various actions. For example, “determine” may include operation, calculation, processing, derivation, investigation, lookup (e.g., look up in a table, a database or another data structure), finding and the like. In addition, “determine” may include receiving (e.g., receiving information), accessing (e.g., accessing data in the memory) and the like. In addition, “determine” may include parsing, choosing, selecting, establishing and the like.

It should be appreciated that embodiments of the present disclosure may be implemented by hardware, software or a combination of the software and combination. The hardware part may be implemented using a dedicated logic; the software part may be stored in the memory, executed by an appropriate instruction executing system, e.g., a microprocessor or a dedicatedly designed hardware. Those ordinary skilled in art may understand that the above apparatus and method may be implemented using a computer-executable instruction and/or included in processor control code. In implementation, such code is provided on a medium such as a programmable memory, or a data carrier such as optical or electronic signal carrier.

In addition, although operations of the present methods are described in a particular order in the drawings, it does not require or imply that these operations must be performed according to this particular sequence, or a desired outcome can only be achieved by performing all shown operations. On the contrary, the execution order for the steps as depicted in the flowcharts may be varied. Additionally or alternatively, some steps may be omitted, a plurality of steps may be merged into one step, or a step may be divided into a plurality of steps for execution. It should be appreciated that features and functions of two or more devices according to the present disclosure may be embodied in one device. On the contrary, features and functions of one device as depicted above may be further divided into and embodied by a plurality of devices.

Although the present disclosure has been depicted with reference to a plurality of embodiments, it should be understood that the present disclosure is not limited to the disclosed embodiments. The present disclosure intends to cover various modifications and equivalent arrangements included in the spirit and scope of the appended claims.

I/We claim:

1. An apparatus for a hyper converged infrastructure, comprising:
at least one computing node each including a first number of storage disks; and
a storage node including a second number of storage disks available for the at least one computing node, the second number being greater than the first number.

2. The apparatus of claim 1, wherein the storage node further includes a storage disk controller associated with a respective one of the at least one computing node, the storage disk controller being provided for the respective computing node to control a storage disk of the second number of storage disks allocated to the respective computing node.

3. The apparatus of claim 1, wherein the at least one computing node includes a plurality of computing nodes, and the second number of storage disks are evenly allocated to the plurality of computing nodes.

4. The apparatus of claim 1, wherein the at least one computing node each further includes at least one of a central processing unit, a memory, and a first interface; and
wherein the storage node further includes a second interface.

5. The apparatus of claim 4, further comprising:
a mid-plane including an interface adapted to interface with the first and second interfaces to establish a connection between the at least one computing node and the storage node.

6. The apparatus of claim 5, wherein the mid-plane further connects the at least one computing node and the storage node to at least one of a power supply module, an I/O module, and a management module in the apparatus.

7. The apparatus of claim 6, wherein the first and second interfaces conform to a same specification.

8. The apparatus of claim 1, wherein the at least one computing node includes three computing nodes, the first number of storage disks include six storage disks, and the second number of storage disks include fifteen storage disks.

9. The apparatus of claim 1, wherein the at least one computing node includes a plurality of computing nodes and the apparatus further includes:
a multi-layer chassis including at least a first layer and a second layer, a part of the plurality of computing nodes is mounted on the first layer, and a further part of the plurality of computing nodes and the storage node are mounted on the second layer.

10. The apparatus of claim 9, wherein the multi-layer chassis includes a 2U chassis.

11. The apparatus of claim 9, wherein the plurality of computing nodes and the storage node are of a same shape.

12. The apparatus of claim 2, wherein the storage node further includes a fan, and the storage disk, the storage disk controller, and the fan are disposed on a movable tray and connected into the storage node via an elastic cable.

13. A method of assembling the apparatus for the hyper converged infrastructure, the method comprising:
providing at least one computing node each including a first number of storage disks; and
providing a storage node including a second number of storage disks available for the at least one computing node, the second number being greater than the first number.

14. The method of claim 13, wherein the storage node further includes a storage disk controller associated with a respective one of the at least one computing node, the storage disk controller being provided for the respective computing node to control a storage disk of the second number of storage disks allocated to the respective computing node.

15. The method of claim 13, wherein the at least one computing node includes a plurality of computing nodes, and the second number of storage disks are evenly allocated to the plurality of computing nodes.

16. The method of claim 13, wherein the at least one computing node each further includes at least one of a central processing unit, a memory, and a first interface; and
wherein the storage node further includes a second interface.

17. The method of claim 16, further comprising:
providing a mid-plane including an interface adapted to interface with the first and second interfaces to establish a connection between the at least one computing node and the storage node.

18. The method of claim 17, wherein the mid-plane further connects the at least one computing node and the storage node to at least one of a power supply module, an I/O module, and a management module in the apparatus.

19. The method of claim 18, wherein the first and second interfaces conform to a same specification.

20. The method of claim 13, wherein the at least one computing node includes three computing nodes, the first number of storage disks include six storage disks, and the second number of storage disks include fifteen storage disks.
